(19) United States
(12) Patent Application Publication
(10) Pub. No.: US 2025/0292584 A1
(43) Pub. Date: Sep. 18, 2025

(54) SYSTEM AND METHOD FOR DETERMINING NEEDS OF GUESTS IN ADVANCE OF AN EMERGENT EVENT

(71) Applicant: Disney Enterprises, Inc., Burbank, CA (US)

(72) Inventors: Gregory Brooks HALE, Orlando, FL (US); Clifford Aron WILKINSON, Clermont, FL (US); Gary D. MARKOWITZ, San Juan Capistrano, CA (US); Jeremy EATON, Winter Garden, FL (US)

(73) Assignee: Disney Enterprises, Inc., Burbank, CA (US)

(21) Appl. No.: 18/607,403

(22) Filed: Mar. 15, 2024

(51) Int. Cl. G06V 20/52; G06V 10/70; G06V 20/40; G06V 40/16

(52) U.S. Cl. CPC G06V 20/53; G06V 10/70; G06V 20/44; G06V 40/178

(57) ABSTRACT

An assistance platform may analyze video data of an environment. Based on analyzing the video data, the assistance platform may recognize an individual out of a plurality of objects in the environment and may recognize a plurality of characteristics exhibited by the individual. The recognized characteristics may affect ability of the individual to respond to an event. The assistance platform may store assistance information identifying the plurality of characteristics; detect that an event has occurred in the environment; and retrieve the assistance information in response to detecting that the event has occurred. The assistance platform may determine, based on the assistance information, an action to be performed to assist the individual The assistance platform may cause the action to be performed to assist the individual; and delete the assistance information after causing the action to be performed.

### BACKGROUND

Closed-circuit television (CCTV) is a system that includes video camera devices that provide signals (e.g., video feeds) to specified monitors located at a specified location. A CCTV system is typically used to perform surveillance of areas monitored by the video camera devices. In this regard, a CCTV system may be used to count, locate, and/or recognize individuals in the areas monitored by the video camera devices.

### SUMMARY

A method performed by a assistance platform, the method comprising: analyzing video data, of an environment, using one or more machine learning models trained to recognize guests and characteristics of the guests; recognizing, based on analyzing the video data, a plurality of guests located in the environment; recognizing, based on analyzing the video data, a plurality of characteristics exhibited by the plurality of guests, wherein the plurality of characteristics affect the ability of at least one guest to respond to an emergent event; determining, prior to detecting the emergent event, one or more characteristics of the plurality of characteristics that are to affect a mobility of a guest, of the plurality of guests, during the emergent event; detecting that the emergent event has occurred; determining, based on the one or more characteristics, an action to be performed to assist the guest during the emergent event; and causing the action to be performed to assist the guest during the emergent event.

A system comprising: one or more camera devices configured to obtain video data of an environment; an assistance platform configured to: analyze the video data of the environment; recognize, based on analyzing the video data, an individual out of a plurality of objects in the environment; recognize, based on analyzing the video data, a plurality of characteristics exhibited by the individual, wherein the recognized characteristics affect ability of the individual to respond to an event; store assistance information identifying the plurality of characteristics and identifying a location for the individual; detect whether the event has occurred in the environment; in response to detecting that the event has occurred, retrieve the assistance information; determine, based on the assistance information, an action to be performed to assist the individual; cause the action to be performed to assist the individual; and delete the assistance information after causing the action to be performed.

A non-transitory computer-readable medium storing a set of instructions, the set of instructions comprising: one or more instructions that, when executed by one or more processors of a device, cause the device to: analyze video data of an environment; recognize, based on analyzing the video data, an individual out of a plurality of objects in the environment; recognize, based on analyzing the video data, a plurality of characteristics exhibited by the individual, wherein at least one of the plurality of characteristics affect the ability of at least one guest to respond to an event; detect that the event has occurred in the environment; determine, based on the one or more characteristics, an action to be performed to assist the individual; and cause the action to be performed to assist the individual.

### BRIEF DESCRIPTION OF THE DRAWINGS

FIGS. 1A-1E are diagrams of an example implementation described herein.

FIG. 2 is a diagram illustrating an example of training and using a machine learning model in connection with recognizing characteristics of individuals.

FIG. 3 is a diagram of example components of one or more devices of FIG. 1.

FIG. 4 is a flowchart of an example process relating to determining needs of guests in advance of an emergent event.

### DETAILED DESCRIPTION

The following detailed description of example implementations refers to the accompanying drawings. The same reference numbers in different drawings may identify the same or similar elements.

Recognizing characteristics of guests in an environment can be helpful in many different types of situations. The different types of situations may include boarding of vehicles, counting the number of guests, locating a missing guest, and/or performing evacuations. In some examples, an operator or venue employee may use a device to count the number of guests and/or to define characteristics of a guest. Additionally, or alternatively, the operator or employee may use a CCTV system to locate and identify a missing guest.

However, the process described above for manually assisting guests based on human observation of guest characteristics is subject to human discrepancies. Incomplete or inaccurate information may reduce effectiveness and timeliness of the assistance provided.

With respect to CCTV systems, it is challenging to simultaneously and constantly monitor the video feeds displayed by the video monitors. Typically, the operator may monitor the video feed of a first video monitor for a period of time and then monitor the video feed of a second video monitor for another period of time. While operators are quite skilled at this task, there is so much information provided in a video feed that it remains possible that some information may not be noticed or that more information may be gleaned from the video feeds than is possible with current methods. For example, the operator may be unable to properly identify characteristics of a guest, such as identifying any mobility restriction of a guest (e.g., determine if the guest uses a wheelchair).

Referring to an evacuation at a venue, reducing the time to evacuate the guests is an important task. Additionally, bringing necessary equipment to assist with the evacuation is also an important task. Currently, first responders do not possess information regarding the characteristics of the guests at the attraction. Accordingly, the evacuation may become a lengthy process, especially if the first responders do not bring the necessary equipment to assist the guests.

For example, the guests may include a guest with mobility restriction (e.g., inability to move, limited mobility, and/or restricted mobility). Accordingly, the guest may require a stair climber to facilitate movement of the guest during the evacuation. First responders do not possess information indicating the mobility restriction and the first responders may not bring the stair chair (or another device to assist the guest). Accordingly, the evacuation may be lengthened due to the first responders not bringing the stair climber.

Accordingly, a need exists for a system to properly and accurately recognize characteristics of guests in order to determine devices or equipment that provide assistance to guests in advance of the different types of situations that may occur at the venue. In this regard, implementations described herein solve the technical problem of determining devices or equipment that provide assistance to guests in advance of the different types of situations that may occur at the venue.

Implementations described herein are directed to a technical solution that includes a system that uses the analysis of video data to recognize the characteristics of individuals prior to an event occurring and analyze information regarding the characteristics to determine an appropriate manner to assist the individuals when the event occurs. The video data may be analyzed using one or more machine learning models trained to recognize the characteristics of individuals. The term “characteristic” (of an individual) may be used to refer to a height of the individual, a body shape of the individual, a weight of the individual and/or articles of clothing. In some examples, the height of the individual may be used to determine an age of the individual.

Additionally, or alternatively, the term “characteristic” may be used to refer to identify any mobility restriction of the individual. For example, the term “characteristic” may be used to indicate whether the individual uses a wheelchair, uses a mobility scooter, uses a cane, uses crutches, uses a leg scooter, is carrying a load (e.g., a package), is pushing a stroller, among other examples of items that restrict the mobility of the individual. Other examples include using assistive devices for sight impairment, hearing impairment, cognitive impairment and the like. Depending on the context and venue, characteristics may also include any detectable characteristic that would impact the person's ability to respond to an emergent event.

The characteristic that relates to a mobility restriction may be referred to as “mobility characteristic.” The mobility characteristic may be used to determine an appropriate response to assist the individual in advance of an event that causes assistance to be provided to the individual. In some situations, a mobility characteristic may be derived from another characteristic. For example, the age of the individual may be indicative of a mobility restriction. For example, the mobility of a child may be dependent on the supervision of a parent.

The video data may be analyzed to recognize the characteristics of the individuals without identifying the individuals. In other words, the identities of the individuals will remain anonymous. In other words, observed characteristics need not include facial recognition, voice recognition, or similar techniques that attempt to identify a specific individual as this disclosure is interested in providing improved assistance to the individual rather than naming or identifying them. The word “recognition” is used rather than identification in this disclosure to mean using enough information to classify an object as, for example, an adult or a child, or as a wheelchair or crutch rather than a person. An important principle followed in the preferred implementations is to gather only so much visual information as is needed to recognize the objects in a scene that are relevant to providing assistance in an emergent event while otherwise providing anonymity to the individuals and protecting against unnecessary information gathering. The term “individual” may be used to refer to a person, a party, a patron, a guest, a passenger, among other examples. The analysis of video data may be referred to as “video analytics.”

In some examples, an assistance platform may receive video data of an environment that includes an individual. The video data may be received (e.g., as a video stream) from one or more camera devices. The environment may include a venue, an establishment providing different types of services, another type of edifice, among other examples. The venue may include attractions, hotels, conference centers, sports/music events, public transportation, and/or the establishment, among other examples. The establishment may include a hotel, a restaurant, among other examples.

The assistance platform may analyze the video data to recognize individuals in the environment and recognize characteristics of the individuals. For example, the assistance platform may analyze frames (e.g., a range of frames of a single camera device or combined frames from multiple camera devices). In some situations, the assistance platform may receive the video data from one or more camera devices capturing individuals (e.g., guests) boarding vehicles of an attraction or public transportation system. The assistance platform may analyze the video data, using one or more machine learning models, to recognize and differentiate the guests from among multiple objects captured in the environment. The assistance platform may further analyze the video data, using the one or more machine learning models, to recognize the characteristics of the guests.

For example, for each vehicle, the assistance platform may determine (or count) a number of guests in the vehicle and may recognize the characteristics of each guest. In some situations, the assistance platform may recognize one or more guests with mobility restrictions in the vehicle. For example, the assistance platform may recognize one or more guests that use a wheelchair, a cane, crutches, among other examples. The recognized characteristics are those characteristics that have been determined by historical information, expert opinion, or otherwise to be relevant to the task of providing assistance in the event of an emergent situation.

Based on analyzing the video data, the assistance platform may generate and store assistance information for the attraction. For example, the assistance information may indicate, for each vehicle, the number of guests in the vehicle and the characteristics of each guest in the vehicle. In this regard, the assistance information may be a guest mapping of each vehicle of the attraction (e.g., a guest mapping of different locations/different portions of the attraction). For example, for a first vehicle, the assistance information may indicate a first total number of guests and a second number of guests with mobility characteristics; for a second vehicle, the assistance information may indicate a third total number of guests and a fourth number of guests with mobility characteristics; and so on. In some implementations the mapping will include information about the relative position of guests with certain characteristics within the vehicle (e.g., a person using crutches is located at row fifteen on a bus or an infant is located at row nineteen on an airplane).

In some situations, the assistance platform may temporarily store the assistance information and/or the video data in a memory of the assistance platform. For example, the assistance information may be stored until the assistance platform detects an event that causes assistance to be provided to the individuals. For instance, the assistance information may be stored until the assistance information is analyzed to determine an appropriate response to the event. In other words, the assistance information may be deleted after the assistance platform determines an appropriate manner to provide assistance to the individuals. In some situations, the assistance information may be deleted after the individuals (to receive assistance) leave the environment. For example, the assistance platform may analyze the video data to determine that the individuals are no longer present in the environment and, accordingly, may delete the assistance information and/or the video data.

The assistance platform may continuously receive the video data (e.g., as a video stream) and may continuously analyze the video data. As a result of continuously analyzing the video data, the assistance platform may continuously update the assistance information. For example, as guests board and deboard each vehicle, the assistance platform may update the assistance information to update the number of guests in each vehicle and update the characteristics of the guests in the vehicle (including updating the number of guests with mobility characteristics).

Analyzing the video data to count the number of guests and/or recognize the characteristics of guests provides an advantage of the venue or the establishment being equipped to respond to the different types of situations described above. In this regard, after counting the number of guests and/or recognizing the characteristics of guests, the assistance platform may detect an occurrence of an event. For example, the assistance platform may receive a notification that the event has occurred. The event may be an emergent event, such as an evacuation. Additionally, or alternatively, the event may be a non-emergent event, such as an anticipated arrival of transportation (e.g., public transportation or private transportation).

In some implementations, a venue may allocate equipment or resources based on the recognized guest characteristics before an emergent event is detected. For example, once it is recognized that a person with walking difficulty is present on a particular floor of a hotel, hotel staff may proactively relocate assistance equipment to that floor. By moving assistance equipment from locations where it is not expected to be needed to locations where it may be more likely to be needed, the hotel can both improve timely response to an emergent event as well as reduce costs associated with duplicative equipment.

Based on detecting the occurrence of the event, the assistance platform may determine an appropriate response based on the assistance information. For example, the assistance platform may retrieve the assistance information (and/or the video data) and may analyze the assistance information to determine the appropriate response. The appropriate response may be implemented manually according to a flowchart, table, or manual of appropriate responses based on the type of event and the guest's needs, or may be automated using, for example, a lookup table of appropriate responses and guest communication or robotic response, or a hybrid where an automated notification is sent to a human monitor who then directs further appropriate response actions.

In some examples, the event may be an evacuation. In this regard, the assistance platform may analyze nature of the event along with the assistance information to determine the number of guests in each vehicle of the attraction and determine one or more guests with mobility restrictions in each vehicle. For instance, the assistance platform may determine that a vehicle includes a guest using a wheelchair. In another example, on a broken ski lift it may be desirable to preferentially evacuate chairs with children or elderly; the techniques described herein allow responders to know which chairs those are and response more efficiently.

Based on analyzing the assistance information, the assistance platform may cause the deployment of one or more devices (or pieces of equipment) that facilitates the evacuation of the guests (e.g., one or more devices that are capable of transporting the total number of guests of the attraction). In some situations, the assistance platform may ensure that the one or more devices (or pieces of equipment) are capable of transporting the guest in need of a wheelchair.

Additionally, or alternatively, the assistance platform may cause the deployment of a device (or equipment) that facilitates the evacuation of the guest in need of a wheelchair. For example, the assistance platform may determine that first responders are to bring a device that facilitates the evacuation of the guest with the wheelchair.

Accordingly, one advantage of retrieving and analyzing the assistance information is to ensure that the appropriate devices or equipment are deployed to assist individuals with mobility restrictions and individuals without mobility restrictions. For at the foregoing advantages and other advantages that will apparent herein, implementations described herein are improvements over existing ways of assisting individuals during emergent events.

In some situations, the assistance platform may provide a notification to the guests. For example, the notification may be provided via the vehicles (e.g., via display devices of the vehicles, via speakers of the vehicles, via mobile devices of the guests, among other examples). The notification may indicate that the one or more devices have been deployed to provide assistance to the guests. Additionally, or alternatively, the notification may include instructions for the guests to facilitate evacuation of the guests.

In some situations, the assistance platform may provide a notification to personnel trained to assist the guests. For example, the notification may be provided to devices of the personnel. The notification may indicate the number of guests that are to receive assistance, the number of guests with mobility restrictions, the locations of the guests, the devices (or pieces of equipment) that are to be deployed to assist the guests, the location of such devices, and/or a manner in which the devices are to be used to assist the guests, among others examples.

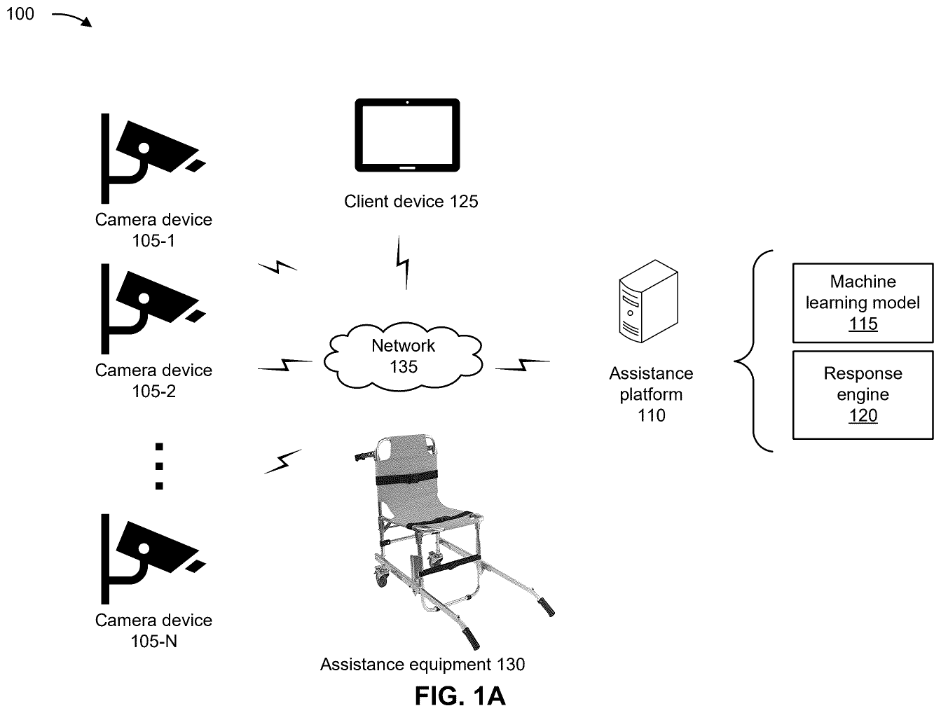

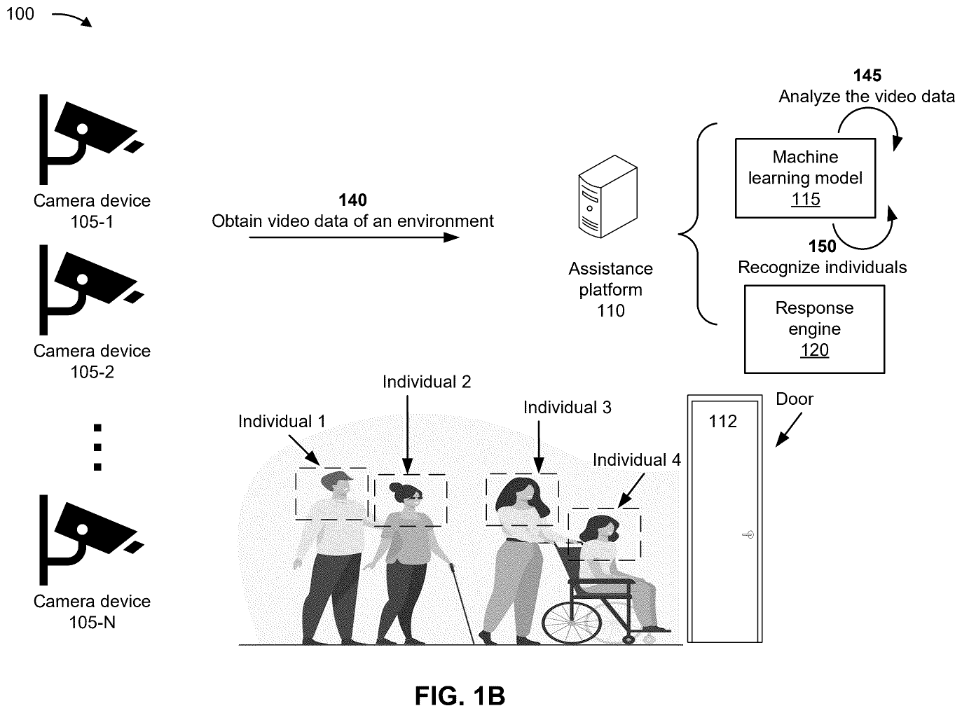

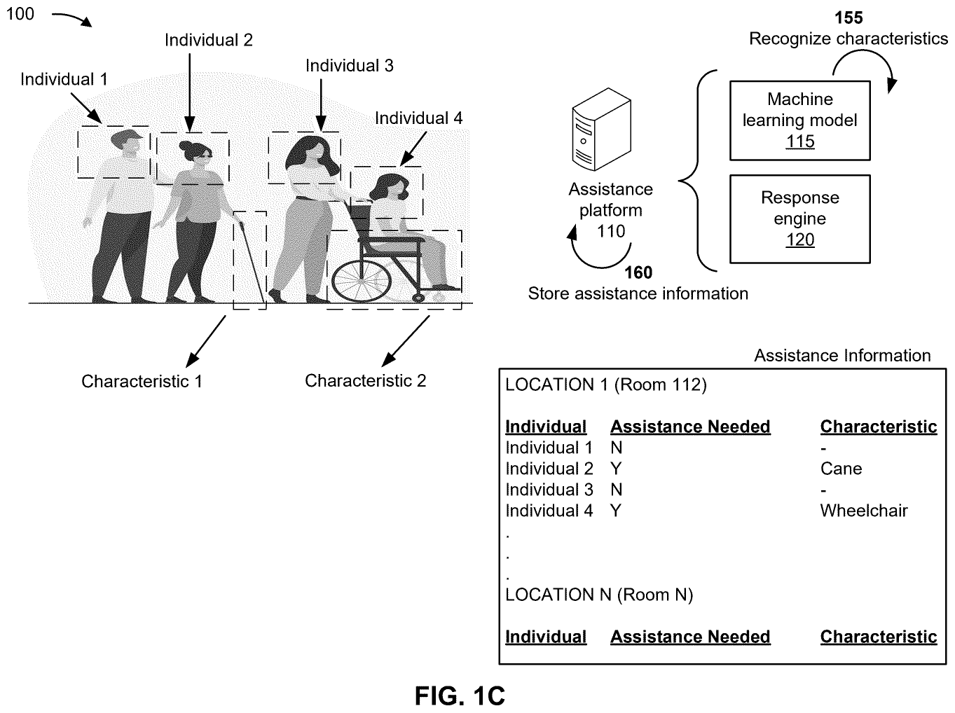

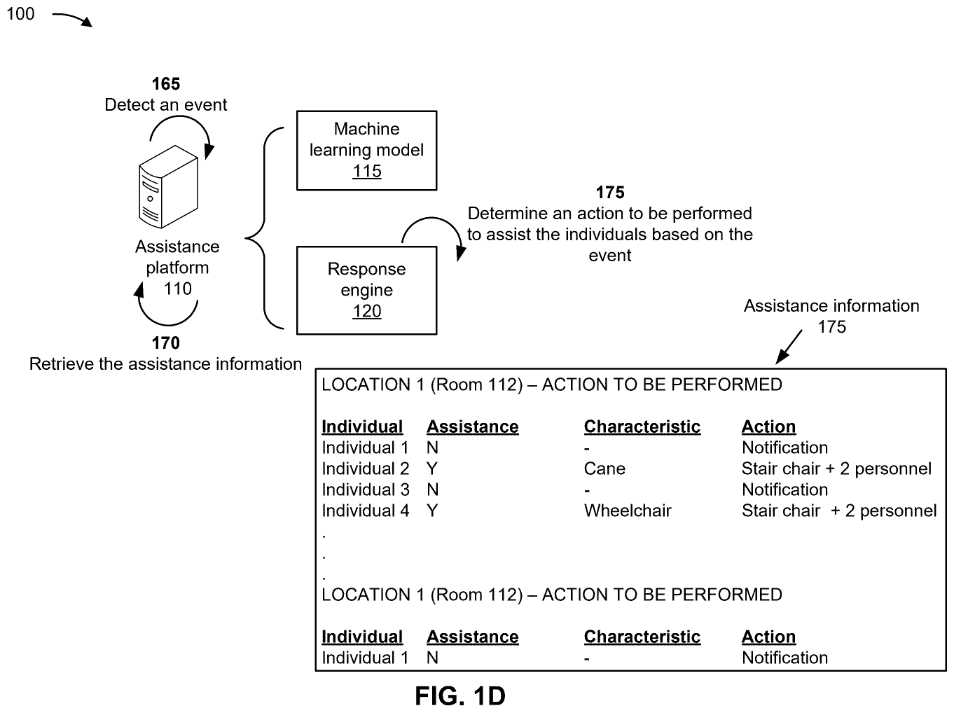

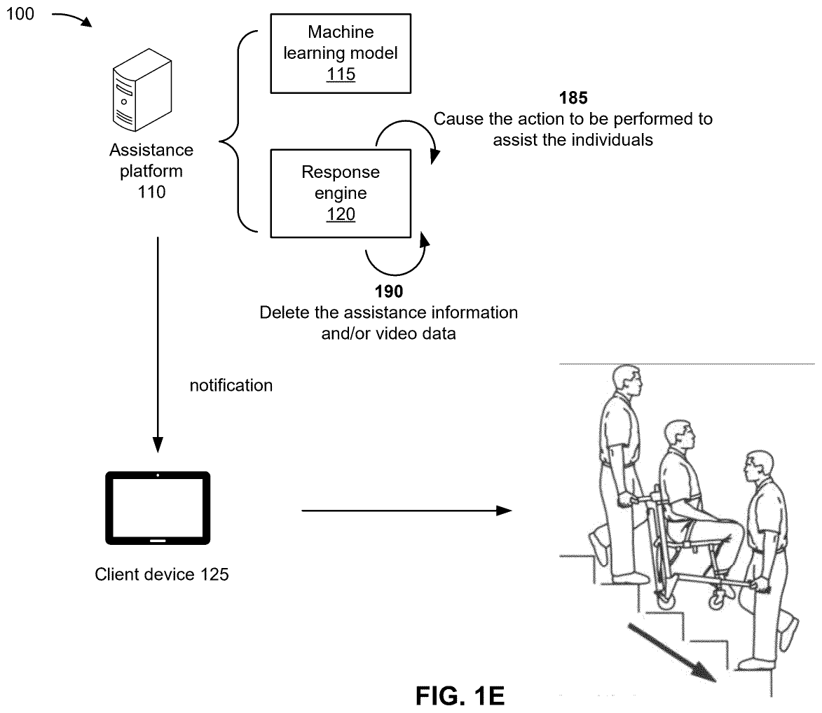

FIGS. 1A-IE are diagrams of an example implementation 100 associated with recognizing characteristics of individuals for preemptively determining assistance for the individuals. As shown in FIGS. 1A-IE, example implementation 100 includes camera devices 105-1, camera device 105-2, to camera device 105-N (collectively camera devices 105 and individually camera device 105), an assistance platform 110, a client device 125, an assistance equipment 130 (to provide assistance to individuals with mobility restrictions), and a network 135.

The devices of FIGS. 1A-IE may be connected via network 135 that includes one or more wired and/or wireless networks. As an example, network 135 may include Ethernet switches. Additionally, or alternatively, network 135 may include a cellular network, a public land mobile network (PLMN), a local area network (LAN), a wide area network (WAN), a private network, the Internet, and/or a combination of these or other types of networks.

Network 135 enables communication between camera devices 105, assistance platform 110, and/or client device 125. Camera devices 105, assistance platform 110, and/or client device 125 may be part of a system configured to recognize characteristics of individuals for preemptively determining assistance for the individuals.

A camera device 105 may include one or more devices configured to capture video data of an environment that includes individuals at a venue and/or an establishment. The camera device 105 may provide the video data to assistance platform 110. In some examples, the camera device 105 may be a monoscopic camera device (or a mono camera device). Alternatively, the camera device 105 may be a stereoscopic camera device (or a stereo camera device). Some or all of camera devices 105 may operate in the visible spectrum, infrared spectrum, or ultraviolet spectrum. Likewise, other scene capture technologies such as LIDAR and RADAR may be appropriate for some applications. Imaging technology is chosen to meet the needs of a particular application.

As shown in FIG. 1A, example implementation 100 may include multiple camera devices 105. Camera devices 105 are coupled by wired or wireless connections to assistance platform 110. Camera devices 105 may provide continuous video/audio streaming or alternatively intermittently stream based on operational needs, triggered programmatically or by motion sensors or other activity triggers.

Assistance platform 110 may include one or more devices configured to process video data to recognize individuals and to recognize characteristics of the individuals. As an example, assistance platform 110 may process the video data to recognize mobility characteristics of the individuals (e.g., to recognize individuals with mobility restrictions). Processing the video data may include various algorithmic techniques to condition raw video data such that objects and features in the video data are more readily analyzed by later object recognition and machine learning models.

This processing may include filtering, adjusting brightness, contrast and color profiles as well as zooming, cropping, rotating and the like. The particular processes chosen and sequence of operations will be adapted to a particular environment and capabilities of camera devices 105.

For example, video from a dark environment may benefit from exposure and contrast enhancement or infrared imagery, while video of a moving vehicle may benefit from rotational translation. In many examples algorithmic feature detection processes are also executed such as edge enhancement and detection processes, corner detection, blob detection, ridge detection and the like are used to as a part of object detection and scene analysis. Example detection techniques include Canny, Deriche, Sobel, Prewitt and/or Roberts edge detection, LoG, DoG, and DoH blob detection, Harris, Shi and Tomasi, level curve curvature corner detection, and Hough transform ridge detection.

As shown in FIG. 1A, assistance platform 110 may include a machine learning model 115 and a response engine 120. Machine learning model 115 may be a machine learning model trained to detect and/or classify objects within an image, such as body parts of individuals and/or characteristics of the individuals, among other examples. Machine learning model 115 may use raw or partially processed video or video frames as input, or may use features (edges, corners, blobs, ridges, and the like) that were identified previously. The body parts may include a head, a neck, shoulders, elbows, wrists, hips, knees, among other examples. The characteristics may include mobility characteristics determined by training the machine learning model to recognize assistive devices such as crutches, canes, wheelchairs, mobility scooters, hearing aids, eyeglasses and the like, including the reliance of people assisting each other. Machine learning model 115 preferably takes context into account in its training and operation such that it is specifically trained to distinguish between individuals, articles of clothing, and/or the items that indicate mobility restrictions, in its input.

In some implementations, machine learning model 115 may implement one or more object recognition techniques. For example, machine learning model 115 may detect and/or classify features within the video data, such as individuals, body parts of individuals, characteristics of individuals, among other examples. For instance, machine learning model 115 may implement a keypoint detection technique and/or a pose estimation technique, among other examples. Additionally, or alternatively, machine learning model 115 may implement a convolutional neural network (CNN), a Single Shot MultiBox Detector (SSD) technique, and/or a You Only Look Once (YOLO) technique, among other examples.

In some implementations, machine learning model 115 may implement one or more segmentation techniques to distinguish between individuals (e.g., humans) and mobility characteristics of the individuals (e.g., wheelchairs, canes, leg scooters, and/or crutches, among other examples). For example, the one or more segmentation techniques may be used to divide an image into different regions based on different characteristics of pixels to identify objects or boundaries. In this regard, machine learning model 115 may implement the one or more segmentation techniques to detect locations of individuals and mobility characteristics within an image.

In some implementations, machine learning model 115 may implement one or more keypoint techniques. For example, the one or more keypoint techniques may be used to determine spatial locations or points parts of an object. In this regard, machine learning model 115 may be configured to detect keypoints for individuals and for mobility characteristics, as discussed herein. The keypoints may be example features that may be detected by machine learning model 115. Other features may include corners, ridges, blobs, and/or edges, among other examples. In some situations, machine learning model 115 may be a deep learning model. In some implementations, the segmentation and the keypoint detection may be performed by one or more additional machine learning models.

In some implementations, machine learning model 115 may be trained using training data that include historical video data of individuals of different ages, individuals of different sizes, individuals of different heights, individuals of different body shapes, individuals of different weights, individuals of different hair colors, individuals of different skin complexion, and/or individuals with different mobility characteristics, among other examples. In some implementations, machine learning model 115 may be trained to recognize the individuals and another machine learning model may be trained to recognize mobility characteristics of the individuals.

Response engine 120 may include one or more devices configured to determine one or more devices (or pieces of equipment) that are to be deployed to provide assistance to the individuals. For example, response engine 120 may analyze the assistance information when an event (e.g., an emergent event) has occurred and may determine the one or more devices to provide assistance to the individuals during the event. Additionally, or alternatively, response engine 120 may determine information that is to be provided to the individuals and/or to personnel trained to assist the individuals. The information may be provided to facilitate a manner in which assistance is provided to the individuals.

Client device 125 may include one or more devices configured to receive information from assistance platform 110 to facilitate a manner in which assistance is to be provided to the individuals. In some examples, client device 125 may be a device of an individual (e.g., a guest), a device of personnel trained to provide assistances to the individual, a device of an operator of a venue or an establishment, among other examples.

Assistance equipment 130 may include a device or equipment that is used to provide assistance to individuals. As shown in FIG. 1A, for example, assistance equipment 130 may include a stair chair. In some situations, assistance equipment 130 may include a lift and/or a rope, among other examples.

As shown in FIG. 1B, and by reference number 140, assistance platform 110 may obtain video data of an environment. For example, assistance platform 110 may receive the video data from one or more camera devices 105 (e.g., camera device 105-1 and/or camera device 105-2). In some examples, assistance platform 110 may receive the video data as a continuous video feed. Additionally, or alternatively, assistance platform 110 may receive the video data periodically (e.g., every second, every ten seconds, every thirty seconds, among other examples). Additionally, or alternatively, assistance platform 110 may receive the video data based on a trigger (e.g., based on a request provided by assistance platform 110 to camera device 105-1).

As an example, the environment may include an establishment, such as a hotel. For instance, the video data may capture individuals in a hall of the hotel. The individuals may be guests in the process of exiting a stairwell or elevator and entering a room (e.g., room 112).

As shown in FIG. 1B, and by reference number 145, assistance platform 110 may analyze the video data. For example, based on receiving the video data, assistance platform 110 may analyze one or more frames of the video data using one or more object recognition techniques (e.g., analyze the video data using machine learning model 115). For example, machine learning model 115 may receive the video data as input and may provide, as an output, information regarding the individuals (e.g., a number of the individuals and/or characteristics of the individuals).

In some implementations, assistance platform 110 may analyze the keypoints using the pose estimation technique (of machine learning model 115). As a result of analyzing the keypoints using the pose estimation technique, assistance platform 110 may determine a pose and/or an orientation of an individual. In some situations, based on the pose and/or the orientation, assistance platform 110 may determine whether the individual is using a cane, using crutches, using a wheelchair, among other examples. Assistance platform 110 (e.g., using machine learning model 115) may determine an action performed by the individuals based on the pose and/or the orientation of the individuals. In some situations, assistance platform 110 may analyze the pose and/or the orientation, using the action recognition technique of machine learning model 115 or another machine learning model, to determine the action. For example, assistance platform 110 may determine whether the individual is moving using a cane, is moving using crutches, is moving using a wheelchair, is sight or hearing impaired among other examples.

As shown in FIG. 1B, and by reference number 150, assistance platform 110 may recognize individuals. For example, based on analyzing the video data, assistance platform 110 (using machine learning model 115) may recognize the individuals captured by the video data. As explained herein, machine learning model 115 may be trained to classify objects as individuals (or humans). Accordingly, based on analyzing the video data, machine learning model may generate (as an output) information that classifies some of the objects in the video data as Individual 1, Individual 2, Individual 3, and Individual 4.

As shown in FIG. 1C, and by reference number 155, assistance platform 110 may recognize characteristics of the individuals. For example, based on analyzing the video data, assistance platform 110 (using machine learning model 115 or another machine learning model) may recognize the characteristics of the individuals captured by the video data. In other words, machine learning model 115 (or another machine learning model) may provide information classifying the characteristics of the individuals.

For each individual, assistance platform 110 may recognize characteristics that may include a height of the individual, a body shape of the individual, a weight of the individual, and/or articles of clothing. As shown in FIG. 1C, assistance platform 110 may recognize additional characteristics, such as mobility characteristics. For example, assistance platform 110 may recognize a first mobility characteristic (Characteristic 1) for Individual 2 and may recognize a second mobility characteristic (Characteristic 2) for Individual 4. For instance, assistance platform 110 may recognize a cane used by Individual 2. Additionally, assistance platform 110 may recognize a wheelchair used by Individual 4.

Assistance platform 110 may obtain additional video data from additional camera devices 105 located at different locations of the establishment (e.g., different public areas in the hotel). Assistance platform 110 may analyze the additional video data to recognize additional individuals located at the different locations.

As shown in FIG. 1C, and by reference number 160, assistance platform 110 may store assistance information. For example, after recognizing the individuals and the characteristics, assistance platform 110 may store the assistance information regarding the individuals and the characteristic. The assistance information may identify the location at which the individual's assistance information was observed, the quantity of individuals at the locations, a need for assistance for each individual (during possible events at the establishment), and a mobility characteristic of each individual.

Assistance platform 110 may determine the need for assistance during possible events, at the establishment, that involve the individuals moving from one location to another. In some implementations, assistance platform 110 may obtain information identifying a list of the possible events. The possible events may include emergent events (such as an evacuation) or non-emergent events (such as visiting an exhibit that spans multiple rooms).

As shown in FIG. 1C, for example, the assistance information may identify the location (e.g., Room 112) and identify the number of individuals at the location. Based on determining that Individual 2 uses a cane, assistance platform 110 may determine that Individual 2 would need assistance during the possible events. Accordingly, as further shown in FIG. 1C, the assistance information may indicate that Individual 2 would need assistance because Individual 2 uses a cane. Based on determining that Individual 4 uses a wheelchair, assistance platform 110 may determine that Individual 4 would need assistance during the possible events. Accordingly, the assistance information may indicate that Individual 4 would need assistance because Individual 4 uses a wheelchair.

The assistance information may store similar information for other rooms of the hotel. In this regard, the assistance information may be a guest mapping of guest needs for assistance (during the possible events) to every location of the establishment. In this regard, the assistance information may be used to determine a manner in which assistance may be provided to the individuals. The assistance information may be temporarily stored in a memory associated with assistance platform 110. For example, the assistance information (for a particular location) may be deleted after one or more of the possible events occur at the particular location and/or after the individuals (needing assistance of the particular location) are relocated.

Assistance platform 110 may continuously or regularly update the assistance information. For example, assistance platform 110 may continuously receive video data of the environment that includes the location. In this regard, assistance platform 110 may continuously analyze the video data to determine when one or more existing individuals are leaving the room, determine when new individuals are entering the room, and recognize characteristics of the new individuals. In other words, assistance platform 110 may continuously update the number of individuals in each location, the characteristics of the individuals, and the need for assistance of the individuals.

As shown in FIG. 1D, and by reference number 165, assistance platform 110 may detect an event. For example, assistance platform 110 may receive a notification that an event has occurred. In one example described herein, the event may be a fire alarm that has been activated at the establishment. Other examples may include a vehicle malfunction or accident, or a common vehicle loading or unloading event. Assistance platform 110 may receive the notification from a device located at the establishment (e.g., the device of personnel at the establishment, a device of a guest at the establishment), from a device located remotely from the establishment and/or from a human observer or other information source.

As shown in FIG. 1D, and by reference number 170, assistance platform 110 may retrieve assistance information 175. For example, based on detecting the event, assistance platform 110 may retrieve assistance information 175. As shown in FIG. 1D, and by reference number 180, assistance platform 110 may determine an action to be performed to assist the individuals based on the event. For example, assistance platform 110 may analyze assistance information 175 to determine the action that may be performed to assist the individuals as a result of the event occurring. For instance, based on determining that the event relates to a fire alarm being activated, assistance platform 110 may determine the individuals are to be evacuated.

Based on analyzing assistance information 175, assistance platform 110 may determine that Individual 2 and Individual 4 would need assistance during the evacuation (because Individual 2 uses a cane and Individual 4 uses a wheelchair). Accordingly, assistance platform 110 may determine a device or equipment that may facilitate Individual 2 and Individual 4 being evacuated. For example, assistance platform 110 may determine that a stair chair (e.g., assistance equipment 130) may facilitate Individual 2 being evacuated along with two personnel to transport Individual 2 in the stair chair. Similarly, assistance platform 110 may determine that an additional stair chair may facilitate Individual 4 being evacuated along with two additional personnel to transport Individual 4 in the stair chair.

Based on analyzing assistance information 175, assistance platform 110 may determine that Individual 1 and Individual 3 do not need mobility assistance during the evacuation. Nevertheless, assistance platform 110 may determine that a notification is to be provided to Individual 1 and Individual 3. For example, the notification may provide instructions to Individual 1 and Individual 3 to facilitate Individual 1 and Individual 3 being evacuated. The instructions may include instructions for self-preservation, instructions to remain calm, to move away from windows, to assist with securing shelter, and/or to direct the individuals to exit ways, among other examples.

Additionally, or alternatively, the notification may indicate that the personnel and/or one or more devices (or pieces of equipment) have been deployed (or dispatched) to provide assistance to the individuals at the location (e.g., the individuals in Room 112), and/or a description of the personnel. Additionally, or alternatively, the notification may indicate an estimate time of arrival of the personnel and/or one or more devices.

As shown in FIG. 1E, the notification may be provided to a display device at the location, to a speaker (or a sound source) at the location, and/or to devices (e.g., client device 125) of the individuals. Based on analyzing assistance information 175, assistance platform 110 may determine to provide an additional notification to devices (e.g., client device 125) of the personnel. The additional notification may identify the location of the individuals, may identify the number of the individuals at the location, may indicate the presences of individuals with mobility restrictions at the location, and/or may identify the one or more devices (or pieces of equipment) that are to be deployed, among other examples.

As shown in FIG. 1E, and by reference number 185, assistance platform 110 may cause the action to be performed to assist the individuals. As shown in FIG. 1E, the notification may be provided to devices of the personnel based on the additional notification, the personnel may properly transport Individual 2 and/or Individual 4. The personnel may include first responders, medical personnel, workers at the establishment, and/or other individuals trained to assist individuals. As shown in FIG. 1E, and by reference number 190, assistance platform 110 may delete assistance information 175 and/or the video data of the environment. For example, based on detecting that the action has performed, assistance platform 110 may delete assistance information 175 and/or the video data.

In some situations, alternatively to delete assistance information 175 and/or the video data of the environment, assistance platform 110 may aggregate data, such as demographic ridership or attendance data by individuals with the different characteristics. For example, for a vehicle of an attraction, assistance platform 110 may aggregate the number of guests in the vehicle over a period of time, the number of guests with mobility characteristics over the period of time, the different types of mobility characteristics recognized over the period of time, the demographics of the guests recognized over the period of time, the number of guests using different seats, among other examples.

In some implementations, assistance platform 110 may perform some analytics using the aggregated data. For example, based on the aggregated data, assistance platform 110 may determine a trend of utilization/usage of the vehicle (e.g., a frequency of usage of the vehicle during the period of time and/or a frequency of usage of different seats during the period of time). Additionally, or alternatively, based on the aggregated data, assistance platform 110 may determine one or more mobility characteristics that are more often recognized in the vehicle, one or more demographics that are more often recognized in the vehicle, among other examples).

Additionally, or alternatively, based on the aggregated data, assistance platform 110 may predict wear of the vehicle and/or of components of the vehicle (e.g., a seat of the vehicle). For example, the aggregated data may indicate an amount of utilization of the vehicle and/or of the components of assistance platform 110. In this regard, assistance platform 110 may predict a maintenance of the vehicle and/or of the components based on the aggregated data. Additionally, or alternatively, assistance platform 110 may predict a repair of the vehicle and/or the components based on the aggregated data. Additionally, or alternatively, assistance platform 110 may predict a replacement of the components based on the aggregated data. While the foregoing example has been described with respect to a vehicle, implementations described herein are applicable to a vehicle that is not part of an attraction, to another mode of transportation (e.g., a bus or a train), to a room, among other examples.

While the foregoing example has been described with respect to individuals using a cane and a wheelchair, implementations described herein are applicable to recognizing other individuals with mobility restrictions, such as an individual pushing a stroller, an individual carrying a load (e.g., packages), and/or an individual that is a child, among other examples. In some situations, a size of an individual and/or a body weight of the individual may be a mobility characteristic. More generally, any characteristic that can be visually detected such as assistive devices, vison impairment, hearing impairment, cognitive impairment and the like that may impede an individual's ability to respond to an emergent event can make use of the instant disclosure to improve timeliness and effectiveness of responding to an emergent event.

As indicated above, FIGS. 1A-IE are provided as an example. Other examples may differ from what is described with regard to FIGS. 1A-IE. The number and arrangement of devices shown in FIGS. 1A-IE are provided as an example. In practice, there may be additional devices, fewer devices, different devices, or differently arranged devices than those shown in FIGS. 1A-IE. Furthermore, two or more devices shown in FIGS. 1A-IE may be implemented within a single device, or a single device shown in FIGS. 1A-IE may be implemented as multiple, distributed devices. Additionally, or alternatively, a set of devices (e.g., one or more devices) shown in FIGS. 1A-1E may perform one or more functions described as being performed by another set of devices shown in FIGS. 1A-IE.

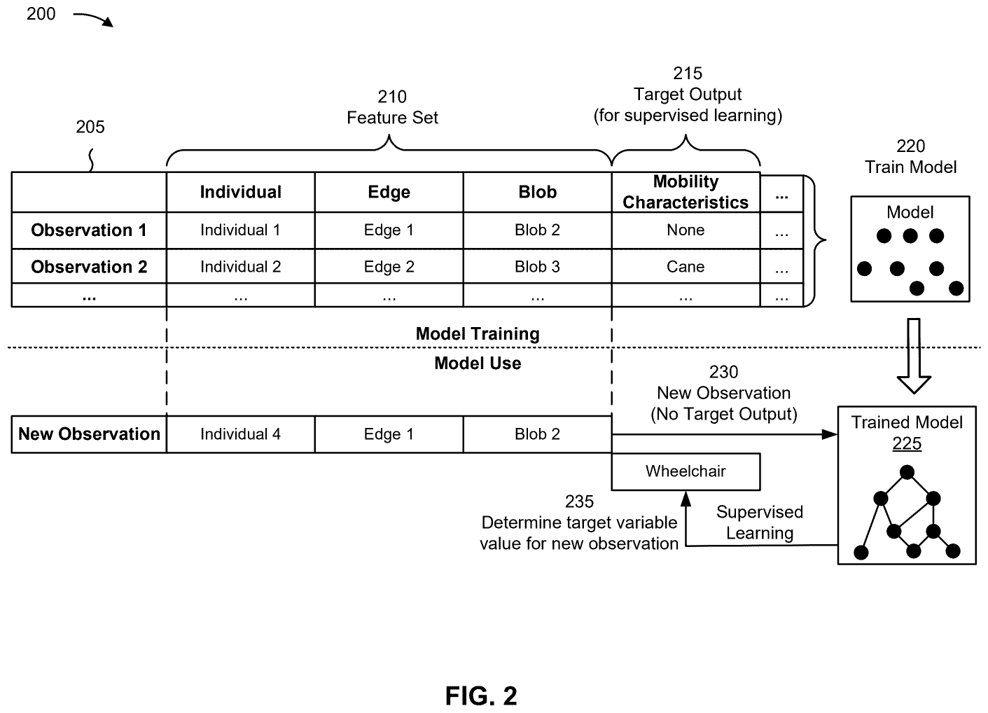

FIG. 2 is a diagram illustrating an example 200 of training and using a machine learning model in connection with recognizing characteristics of individuals. The machine learning model training and usage described herein may be performed using a machine learning system. The machine learning system may include or may be included in a computing device, a server, a cloud computing environment, or the like, such as camera devices 105, assistance platform 110, and/or client device 125.

As shown by reference number 205, a machine learning model may be trained using a set of observations. The set of observations may be obtained from training data (e.g., historical data), such as data gathered during one or more processes. In some implementations, the machine learning system may receive the set of observations (e.g., as input) from camera devices 105. The observations 205 are designed to include examples of various kinds of assistive devices in use by a wide variety of individuals. For example, for individuals to be accurately recognized, observations 205 should include many sizes, shapes, ages, races, genders and the like to ensure unbiased recognition of individuals. Similarly, observations 205 should include many examples of assistive devices such as wheelchairs, canes, mobility scooters, eyeglasses, hearing aids and the like, as well as being able to detect when an individual relies on assistance from another individual to be mobile.

As shown by reference number 210, the set of observations may include a feature set. The feature set may include a set of values, and a value may be referred to as a feature. A specific observation may include a set of values. In some implementations, the machine learning system may determine values for a set of observations and/or values for a specific observation based on input received from camera devices 105. For example, the machine learning system may identify a feature set (e.g., one or more features and/or feature values) by extracting the feature set from structured data, by unsupervised learning techniques to extract the feature set from unstructured data, and/or by receiving input from an operator.

As an example, a feature set for a set of observations may include a first feature set of individual, a second feature set of edge, a third feature set of mobility characteristics, and so on. As shown, for a first observation, the first feature set is labeled “Individual 1,” the second feature set is labeled “Edge 1,” the third feature set is labeled “Blob 2,” and so on. These features sets are provided as examples, and may differ in other examples. Feature set “Individual 1” contains data representing features extracted from Observation 1 that pertain to an individual represented in the observation, e.g., age, size, body shape, and the like. Feature set “Edge 1” contains data representing features extracted from Observation 1 that pertain to the edges of a mobility characteristic of Individual 1. Feature set “Blob 2” contains data representing features extracted from Observation 1 that pertain to the blobs regarding the mobility characteristic. For example, the feature set may include one or more of the following features: corners, ridges, keypoints, location, time of the day, among other examples.

As shown by reference number 215, the set of observations may be associated with a target output. The target output may be represented by a numeric value, may represent a numeric value that falls within a range of values or has some discrete possible values, may represent a value that is selectable from one of multiple options (e.g., one of multiples classes, classifications, or labels) and/or may represent a Boolean value. A target output may be specific to an observation. In example 200, the target output is mobility characteristics, which has a value of “None” for the first observation. In other words, the first observation may indicate that the individual is not using a mobility assistive device. Accordingly, the machine learning model may be trained, based on the feature set, to classify the observation as having identified a mobility characteristic or not having identified a mobility characteristic.

The target output may represent an output that a machine learning model is being trained to predict, and the feature sets may represent the inputs used to a train a machine learning model. The set of observations may be associated with target output values so that the machine learning model can be trained to recognize patterns in the feature set that lead to a target output. A machine learning model 115 that is trained using human feedback during training may be referred to as a supervised learning model. In some implementations, the machine learning model 115 may be trained on a set of observations that do not include a target output. This may be referred to as an unsupervised learning model. In this case, the machine learning model may learn patterns from the set of observations without labeling or supervision, and may provide output that indicates such patterns, such as by using clustering and/or association to identify related groups of items within the set of observations. The choice between supervised and unsupervised learning models is determined in a particular instance based on availability of training resources, time, cost, and achieving a desired ability to recognize individuals and objects during operation with sufficient accuracy to meet the needs of a particular application.

As shown by reference number 220, the machine learning system may train a machine learning model using the feature sets 210 extracted from the observations 205 and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model (Trained Model 225) to be used to analyze new observations.

As shown by reference number 230, once trained, the machine learning system may apply Trained Model 225 to a new observation, such as by receiving a new observation and inputting the new observation to Trained Model 225. As shown, the new observation may include a first feature set of “Individual 4,” a second feature set of “Edge 1,” a third feature set of “Blob 2,” and so on, as an example. The machine learning system may apply Trained Model 225 to the new observation to generate an output (e.g., a result). The type of output may depend on the type of machine learning model and/or the type of machine learning task being performed. For example, the output may include a predicted value of a target output, such as when supervised learning is employed.

As an example, Trained Model 225 may predict a value of “Wheelchair” for the target variable of mobility characteristics for the new observation, as shown by reference number 235. This prediction is temporarily stored along with the location of the individual, preferably only for a time period during which the prediction is useful in providing assistance to an individual.

In this way, the assistance platform 110 may apply a rigorous and automated process to provide a response to whether an individual has a mobility restriction. The machine learning system enables recognition and/or identification of tens, hundreds, thousands, or millions of features and/or feature values for tens, hundreds, thousands, or millions of observations, thereby increasing accuracy and consistency and reducing delay associated with responding to observable events by human operators manually directing response.

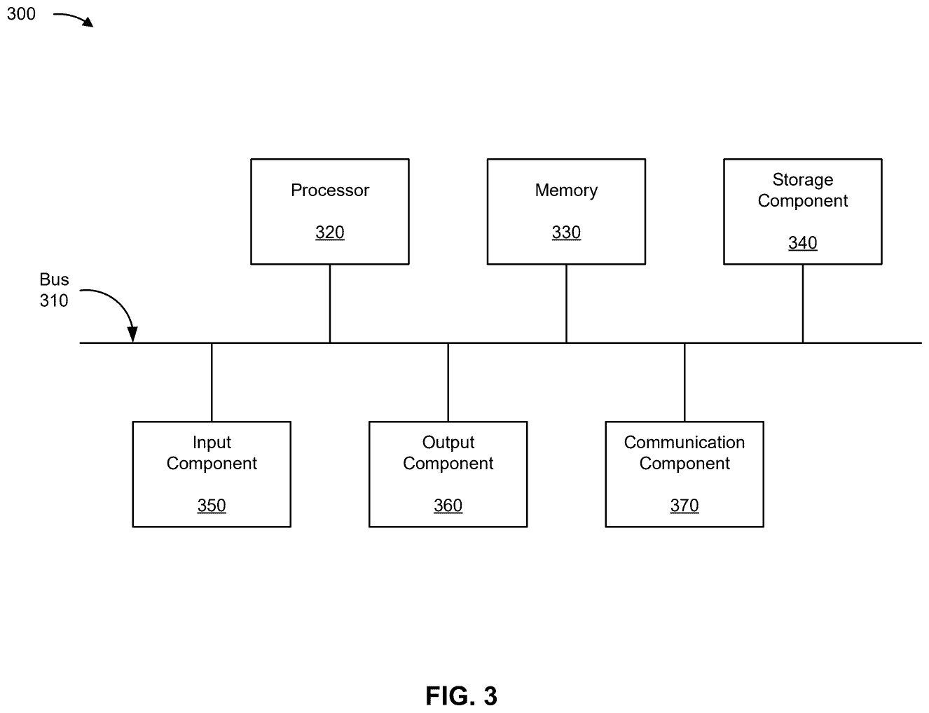

FIG. 3 is a diagram of example components of a device 300, which may correspond to camera devices 105, assistance platform 110, and/or client device 125. In some implementations, camera devices 105, assistance platform 110, and/or client device 125 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as guest input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

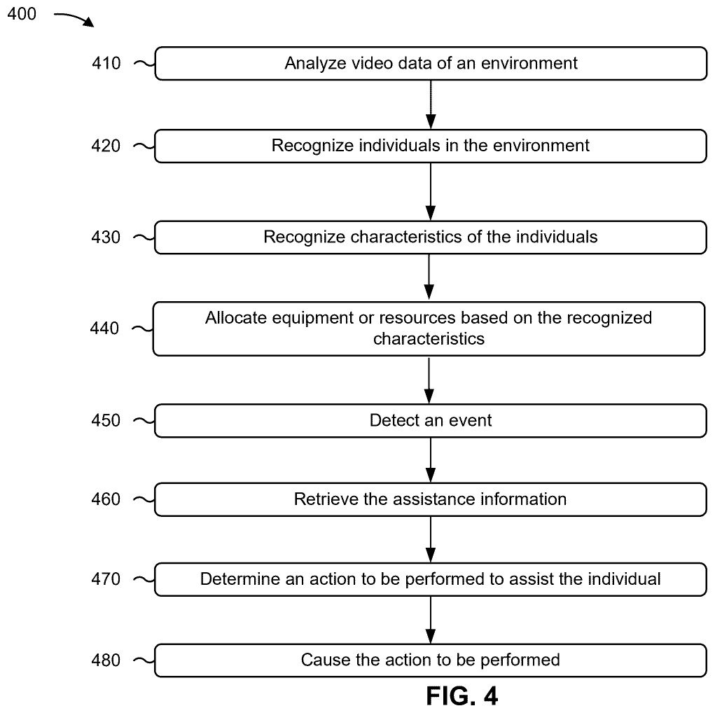

FIG. 4 is a flowchart of an example process 400 relating to determining needs of guests in advance of an emergent event. In some implementations, one or more process blocks of FIG. 4 may be performed by an assistance platform (e.g., assistance platform 110). In some implementations, one or more process blocks of FIG. 4 may be performed by another device or a group of devices separate from or including the prediction platform, such as a camera device (e.g., camera device 105-1) and/or a client device (e.g., client device 125). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include analyzing video data of an environment (block 410). For example, the assistance platform may obtain video data of an environment that includes individuals who may or may not be using mobility assistive devices. The assistance platform may obtain continuous video/audio streaming or alternatively intermittently stream from one or more camera devices 105 located in the environment.

As further shown in FIG. 4, process 400 may include recognizing individuals in the environment (block 420). For example, the assistance platform may use one or more machine learning models to analyze the video data to distinguish the individuals from objects in the environment. As an example, the individuals may be waiting for a vehicle at a boarding/deboarding location of a transportation system. Alternatively, the individuals may be onboarding the vehicle.

As further shown in FIG. 4, process 400 may include recognizing characteristics of the individuals (block 430). For example, the assistance platform may use one or more machine learning models to analyze the video data to recognize mobility characteristics of one or more of the individuals. For example, the assistance platform may recognize one or more of the individuals moving using a cane, moving using a wheelchair, pushing a stroller, and/or carrying a load (e.g., boxes, packages, and/or bags), among other examples.

In some implementations, the video data may be analyzed using the action recognition technique (e.g., of the machine learning model or an additional machine learning model) to identify an action performed by the individuals. The action may include one or more of the individuals moving using a cane, moving using a wheelchair, pushing a stroller, and/or carrying a load (e.g., boxes, packages, and/or bags), among other examples. The action recognition technique may include a sensor-based activity recognition technique, a Wi-Fi-based activity recognition technique, a vision-based activity recognition technique, a data-mining-based activity recognition technique, among other examples. In some examples, identifying the action may include analyzing data from multiple observations over a period of time.

As further shown in FIG. 4, process 400 may include allocating equipment or resources based on the recognized characteristics (block 440). For example, the assistance platform may cause proactive actions to be performed prior to detecting an event that may require assistance to be provided to one or more of the individuals. In some situations, the assistance platform may provide information to a device of an operator at the venue and/or to a device of a venue employee to instruct the operator and/or the venue employee to take the proactive actions prior to the event. The assistance platform may cause staging of equipment and/or allocation of personnel in advance of detecting the event. As an example, the assistance platform may alert the operator or the venue employee (at a debarkation location for public transportation) that one or more individuals will need assistance boarding the vehicle and/or deboarding the vehicle. Accordingly, the operator or the venue employee may allocate the appropriate equipment or resources prior to the event in order to timely assist the one or more individuals during the event.

As further shown in FIG. 4, process 400 may include detecting an event (block 450). For example, the assistance platform may receive a notification regarding the event. In some situations, the notification may indicate that the vehicle (e.g., a bus) is arriving at the boarding/deboarding location. Alternatively, the notification may indicate that the vehicle is to be evacuated (e.g., due to the vehicle being disabled). The notification may be received from one or more devices associated with the vehicle.

As further shown in FIG. 4, process 400 may include retrieving the assistance information (block 460). For example, based on detecting the event, the assistance platform may retrieve the assistance information 175 and analyze the assistance information to recognize one or more individuals with mobility characteristics.

As explained herein, the assistance information 175 may indicate the one or more individuals with mobility characteristics. For example, the assistance information 175 may indicate that the one or more individuals include an individual using a wheelchair. Additionally, or alternatively, the assistance information 175 may indicate a location of the individual. Additionally, or alternatively, the assistance information 175 may indicate equipment that may be used to provide assistance to the individual.

As further shown in FIG. 4, process 400 may include determining an action to be performed to assist the individual (block 470). For example, based on the assistance information 175, the assistance platform may provide a notification to the device of the venue employee to cause the venue employee to provide assistance to the individual (e.g., to board the vehicle). For example, the notification may identify an estimated time of arrival of the vehicle and may identify the boarding/deboarding location (e.g., a bus stop number). As another example, based on the assistance information 175, the assistance platform may provide a notification to a device of a first responder to cause the first responder to provide assistance to the individual (in the event the vehicle is to be evacuated). For example, the notification may identify a location of the vehicle, may indicate the equipment that is to be used to assist the individual to deboard the vehicle, and/or may provide instructions on a manner in which the equipment is to be used, among other examples.

As further shown in FIG. 4, process 400 may include cause the action to be performed to assist the individual (block 480). For example, the assistance platform may cause the operator, the venue employee, and/or the first responder to provide assistance to the individual as described herein. In some situations, the assistance platform may cause a bus with appropriate accommodation for wheelchairs to be dispatched to the location of the vehicle (in the event the vehicle is to be evacuated).

By causing the bus with appropriate accommodation to be dispatched, the assistance platform may enable the individual to be evacuated in a timely manner instead of waiting for one or more subsequent buses. Accordingly, the assistance platform may reduce the wait time of the individual.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method performed by an assistance platform, the method comprising:
analyzing video data, of an environment, using one or more machine learning models trained to recognize guests and characteristics of the guests;
recognizing, based on analyzing the video data, a plurality of guests located in the environment;
recognizing, based on analyzing the video data, a plurality of characteristics exhibited by the plurality of guests, wherein the plurality of characteristics affect the ability of at least one guest to respond to an emergent event;
determining, prior to detecting the emergent event, one or more characteristics of the plurality of characteristics that are to affect a mobility of a guest, of the plurality of guests, during the emergent event;
detecting that the emergent event has occurred;
determining, based on the one or more characteristics, an action to be performed to assist the guest during the emergent event; and
causing the action to be performed to assist the guest during the emergent event.

2. The method of claim 1, wherein determining the one or more characteristics comprises one or more of:
determining, based on analyzing the video data, a characteristic indicating a mobility restriction of the guest;
determining, based on analyzing the video data, a characteristic indicating an age of the guest; or
determining, based on analyzing the video data, a characteristic indicating that the guest is carrying a load.

3. The method of claim 1, wherein determining the action comprises:
determining, based on the one or more characteristics, equipment configured to assist guests with the one or more characteristics during the emergent event, and
wherein causing the action to be performed comprises:
causing the equipment to be dispatched to assist the guest during the emergent event.

4. The method of claim 1, wherein determining the action comprises:
determining, based on the one or more characteristics, personnel trained to assist guests with the one or more characteristics during the emergent event, and
wherein causing the action to be performed comprises:
causing the personnel to be dispatched to assist the guest during the emergent event.

5. The method of claim 1, wherein determining the action comprises:
generating, based on the one or more characteristics, information to assist guests with the one or more characteristics during the emergent event, and
wherein causing the action to be performed comprises:
causing the information to be provided to the guest to assist the guest during the emergent event.

6. The method of claim 1, further comprising:
storing, prior to detecting that the emergent event occurred, assistance information identifying the plurality of characteristics and identifying locations of a particular one of the guests of the plurality of guests, wherein the particular one guest exhibits the characteristics;
retrieving the assistance information; and
analyzing the assistance information to determine the one or more characteristics.

7. The method of claim 6, further comprising:
deleting the assistance information after causing the action to be performed.

8. A system, comprising:
one or more camera devices configured to obtain video data of an environment;
an assistance platform configured to:
analyze the video data of the environment;
recognize, based on analyzing the video data, an individual out of a plurality of objects in the environment;
recognize, based on analyzing the video data, a plurality of characteristics exhibited by the individual, wherein the recognized characteristics affect ability of the individual to respond to an event;
store assistance information identifying the plurality of characteristics and identifying a location for the individual;
detect whether the event has occurred in the environment;
in response to detecting that the event has occurred, retrieve the assistance information;
determine, based on the assistance information, an action to be performed to assist the individual;
cause the action to be performed to assist the individual; and
delete the assistance information after causing the action to be performed.

9. The system of claim 8, wherein the individual is a first individual,
wherein the plurality of characteristics are a first plurality of characteristics, and
wherein the assistance platform is further configured to:
recognize, based on analyzing the video data, a second individual in the environment;
recognize, based on analyzing the video data, a second plurality of characteristics exhibited by the second individual; and
update the assistance information to further identify the second plurality of characteristics.

10. The system of claim 9, wherein the assistance platform is further configured to:
provide the assistance information for display to provide assistance to the second individual.

11. The system of claim 9, wherein the action is a first action, and
wherein the assistance platform is further configured to:
determine, based on one or more second characteristics of the second plurality of characteristics, a second action to be performed to assist the second individual; and
cause the second action to be performed to assist the second individual.

12. The system of claim 11, wherein the one or more first characteristics are different than the one or more second characteristics, and
wherein the first action is different than the second action based on the one or more first characteristics being different than the one or more second characteristics.

13. The system of claim 8, wherein the assistance platform is further configured to:
determine a location of the individual, and
wherein, to store the assistance information, the assistance platform is further configured to:
store the assistance information,
wherein the assistance information further identifies the location of the individual.

14. The system of claim 8, wherein the assistance platform is further configured to:
determine whether the event can no longer occur or that the individual has left the location where the event could occur; and
in response to detecting that the event has not occurred the event can no longer occur or that the individual has left the location where the event could occur, delete the assistance information.

15. A non-transitory computer-readable medium storing a set of instructions, the set of instructions comprising:
one or more instructions that, when executed by one or more processors of a device, cause the device to:
analyze video data of an environment;
recognize, based on analyzing the video data, an individual out of a plurality of objects in the environment;
recognize, based on analyzing the video data, a plurality of characteristics exhibited by the individual, wherein at least one of the plurality of characteristics affect the ability of at least one guest to respond to an event;
detect that the event has occurred in the environment;
determine, based on the one or more characteristics, an action to be performed to assist the individual; and
cause the action to be performed to assist the individual.

16. The non-transitory computer-readable medium of claim 15, wherein the event is a first event, and
wherein the one or more instructions further cause the device to:
store assistance information identifying the plurality of characteristics;
retrieve the assistance information;
analyze the assistance information to determine the one or more characteristics; and
delete the assistance information based on detecting a second event.

17. The non-transitory computer-readable medium of claim 16, wherein the one or more instructions, that cause the device to delete the assistance information, cause the device to:
detect that the individual has relocated away from the environment; and
delete the assistance information based on detecting that the individual has relocated away from the environment.

18. The non-transitory computer-readable medium of claim 16, wherein the one or more instructions, that cause the device to delete the assistance information, cause the device to:
delete the assistance information based on causing the action to be performed.

19. The non-transitory computer-readable medium of claim 15, wherein the one or more instructions, that cause the device to recognize the plurality of characteristics, cause the device to one or more of:
determine, based on analyzing the video data, a characteristic indicating a mobility restriction of the individual;
determine, based on analyzing the video data, a characteristic indicating an age of the individual; or
determine, based on analyzing the video data, a characteristic indicating that the individual is carrying a load.

20. The non-transitory computer-readable medium of claim 16, wherein the one or more instructions, that cause the device to perform the action, cause the device to:
determine, based on the one or more characteristics, equipment from a plurality of equipment and cause the equipment to be dispatched to assist the individual during the event; or
determine, based on the one or more characteristics, personnel from a plurality of personnels and cause the personnel, trained to assist during the event, to be dispatched to assist the individual during the event.
